(19) United States
(12) Patent Application Publication
(10) Pub. No.: US 2010/0068591 A1
(43) Pub. Date: Mar. 18, 2010

(54) FUEL CELL CATALYST, FUEL CELL CATHODE AND POLYMER ELECTROLYTE FUEL CELL INCLUDING THE SAME

(76) Inventor: Tetsuo KAWAMURA, (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/521,998

(22) PCT Filed: Jan. 9, 2008
(86) PCT No.: PCT/JP2008/050469

§ 371 Date: Jul. 2, 2009

(30) Foreign Application Priority Data
Jan. 10, 2007 (JP) 2007-002773

(51) Int. Cl. H01M 8/10; H01M 4/00

(52) U.S. Cl. 429/30; 429/40

(57) ABSTRACT

The present invention actualizes a polymer electrolyte fuel cell that exhibits a high durability even when undergoing electric potential variation cycles. Used is a fuel cell catalyst characterized in that a metal catalyst, and an oxide of niobium (Nb2O5) and/or an oxide of tantalum (Ta2O5) are supported on a conductive material.

### TECHNICAL FIELD

The present invention relates to a fuel cell catalyst, a fuel cell cathode and a polymer electrolyte fuel cell including the same.

### BACKGROUND ART

Polymer electrolyte fuel cells including polymer electrolyte membranes can be easily reduced in size and weight, and hence are expected to be practically used as electric power sources and the like for mobile vehicles such as electric automobiles and compact cogeneration systems. However, polymer electrolyte fuel cells are relatively lower in operation temperature, and it is difficult to effectively use the exhaust heat therefrom as complementary mobile power and the like; accordingly, for the purpose of practically applying polymer electrolyte fuel cells, demanded is performance enabling achievement of high power generation efficiency and high output density under the operation conditions that the utilization rate of the anode reaction gas (pure hydrogen or the like) and the utilization rate of the cathode reaction gas (air or the like) are high.

The cathode catalyst layer of a polymer electrolyte fuel cell is mainly composed of Pt-supported carbon and a proton conductive electrolyte. The oxygen fed from the outside, protons migrating from the anode through the electrolyte membrane into the electrolyte in the catalyst layer, and the electrons migrating from the anode through the external circuit in the carbon undergo the cathode reaction on the Pt to generate power.

The catalyst such as Pt supported on the carbon support in the cathode electrode is decreased in the electrochemically active reaction surface area with time in the course of long time test of the fuel cell, and the degradation of cell performance and the like are thereby caused.

Conceivably, the reasons for causing such problems may be described as follows: the interiors of the electrodes are high in acidity, in particular, the cathode electrode is exposed to a high voltage in the vicinity of 1 V; accordingly the catalyst such as Pt is ionized to be dissolved, and migrates into the interior of the electrolyte membrane to be redeposited, or migrates on the surface of the carbon support to undergo coagulation (sintering); thus, the reaction surface area is decreased with time.

Patent Document 1 shown below discloses an invention taking into consideration the sintering of the metal catalyst on the catalyst particles. Specifically, for the purpose of providing a catalyst particle higher in activity and capable of exhibiting activities in relation to two or more types of materials, JP Patent Publication (Kokai) No. 2003-80077 A discloses a base particle having a primary particle size of the order of nanometers that is a microparticle composed of an elemental substance or a solid solution microparticle composed of two or more elemental substances, and a catalyst particle composed of the base particle and a surface coating layer, composed of one or more noble metal elements or one or more noble metal oxides, covering at least a part of the surface of the base particle in a thickness of 1 to 30 atomic layers. It is to be noted that the “base particle” as referred to in JP Patent Publication (Kokai) No. 2003-80077 A means a material selected from metal oxides, metal carbides and carbon materials, and more specifically, from the oxides of Ce, Zr, Al, Ti, Si, Mg, W and Sr.

### DISCLOSURE OF THE INVENTION

According to the investigation carried out by the present inventors, it has been found that many of the oxides of Ce, Zr, Al, Ti, Si, Mg, W and Sr disclosed in JP Patent Publication (Kokai) No. 2003-80077 A are ionized and eluted under the conditions of 1 V and PH<0 or 0.75 V and PH<0 for the cathode at the time of the fuel cell operation, but only W is present as WO₃ even under the conditions of 1 V and PH<0 or 0.75 V and PH<0. However, as described below, it has been revealed that most of the WO₃ is also eluted after an electrochemical cycle test, and hence WO₃ is not necessarily effective in preventing the sintering of the fuel cell electrode catalyst.

Accordingly, an object of the present invention is to alleviate the reaction area reduction of the metal catalyst and the performance degradation of the fuel cell by suppressing the coagulation of the metal catalyst brought about by long time use of the fuel cell.

The present inventors have reached the present invention by discovering that the above-described problems can be solved by disposing on the support a specific sintering preventing material to inhibit the coagulation of the metal catalyst.

Specifically, a first aspect of the present invention is a fuel cell catalyst characterized in that a metal catalyst and an oxide of niobium (Nb₂O₅) and/or an oxide of tantalum (Ta₂O₅) are supported on a conductive support.

A second aspect of the present invention is a fuel cell cathode including the above-described fuel cell catalyst; the fuel cell cathode includes a catalyst layer composed of a metal catalyst-supported conductive material and a polymer electrolyte, the fuel cell cathode being characterized in that the oxide of niobium (Nb₂O₅) and/or the oxide of tantalum (Ta₂O₅) is further supported on the catalyst-supported conductive material.

A third aspect of the present invention is a polymer electrolyte fuel cell including the above-described fuel cell cathode; the polymer electrolyte fuel cell includes an anode, a cathode and a polymer electrolyte membrane disposed between the anode and the cathode, and is characterized in that: the cathode includes a catalyst layer composed of a metal catalyst-supported conductive material and a polymer electrolyte; and the oxide of niobium (Nb₂O₅) and/or the oxide of tantalum (Ta₂O₅) is further supported on the catalyst-supported conductive material.

According to the present invention, by further supporting the oxide of niobium (Nb₂O₅) and/or the oxide of tantalum (Ta₂O₅) on the catalyst-supported conductive material, the coagulation of the catalyst metal particles due to the fuel cell operation is suppressed, and the reaction area reduction of the metal catalyst and the performance degradation of the fuel cell are thereby alleviated. Consequently, a high power generation performance can be maintained for a long time. In particular, even when the fuel cell undergoes electric potential variation cycles, the fuel cell can be made to exhibit a high durability.

### BRIEF DESCRIPTION OF THE DRAWINGS

FIG. 1 is a graph showing the results of an electrochemical elution test for a conventional sintering preventing agent WO₃, and sintering preventing agents of the present invention, namely, an oxide of niobium (Nb₂O₅) and an oxide of tantalum (Ta₂O₅);

FIG. 2 shows the maintenance rate transition of the catalyst reaction area brought about by the endurance of the electric potential variation; and

FIG. 3 shows the results of the performance degradation brought about by the electric potential variation test.

### BEST MODE FOR CARRYING OUT THE INVENTION

Hereinafter, detailed description will be made on preferred embodiments of the fuel cell electrode catalyst, the fuel cell cathode and the polymer electrolyte fuel cell including the fuel cell cathode of the present invention.

No particular constraint is imposed on the catalyst included in the catalyst-supported conductive material in the cathode of the present invention; however, as such a catalyst, platinum or a platinum alloy is preferable. Further, the catalyst included in the catalyst-supported conductive material is preferably supported on an electrically conductive support. No particular constraint is imposed on such a support; however, preferable as such a support is a carbon material having a specific surface area of 200 m²/g or more. For example, carbon black and activated carbon are preferably used.

Additionally, as the polymer electrolyte included in the catalyst layer of the present invention, a fluorine-containing ion exchange resin is preferable; in particular, preferable is a sulfonic acid-type perfluorocarbon polymer. The sulfonic acid-type perfluorocarbon polymer is chemically stable in the cathode for a long period of time and enables rapid proton conduction.

Additionally, the layer thickness of the catalyst layer of the cathode of the present invention can be comparable with the thickness of a common gas diffusion electrode, and is preferably 1 to 100 μm, and more preferably 3 to 50 μm.

In a polymer electrolyte fuel cell, the overvoltage of the oxygen reduction reaction in the cathode is usually extremely larger as compared to the overvoltage of the hydrogen oxidation reaction in the anode, and hence for the purpose of improving the output performance of the cell, it is effective to improve the electrode characteristics of the cathode by increasing the oxygen concentration in the vicinity of the reaction site in the catalyst layer of the cathode as described above and by effectively using the reaction site.

On the other hand, no particular constraint is imposed on the structure of the anode; for example, the anode may have the structure of the heretofore known gas diffusion electrode.

Additionally, no particular constraint is imposed on the polymer electrolyte membrane used in the polymer electrolyte fuel cell of the present invention as long as the polymer electrolyte membrane is an ion exchange membrane capable of exhibiting satisfactory ion conductivity under humidified conditions. Examples of the usable solid polymer material constituting the polymer electrolyte membrane include a perfluorocarbon polymer having sulfonic acid groups, polysulfone resin, and a perfluorocarbon polymer having phosphonic acid groups or carboxylic acid groups. Preferable among these is the sulfonic acid-type perfluorocarbon polymer. In addition, this polymer electrolyte membrane may be formed of the same resin as or different from the fluorine-containing ion exchange resin included in the catalyst layer.

The catalyst layer of the cathode of the present invention can be prepared by using a conductive material on which a catalyst and an oxygen absorbing/releasing material are beforehand supported and a liquid coating composition prepared by dissolving a polymer electrolyte in a solvent or by dispersing a polymer electrolyte in a dispersion medium. Alternatively, the catalyst layer of the cathode can be prepared by using a liquid coating composition prepared by dissolving in a solvent or dispersing in a dispersion medium a catalyst-supported conductive material, a polymer electrolyte and an oxygen absorbing/releasing material. Examples of the solvent or dispersion medium usable in this case include an alcohol, a fluorine-containing alcohol and a fluorine-containing ether. The catalyst layer is formed by applying the liquid coating composition to a carbon cloth or the like to serve as an ion exchange membrane or a gas diffusion layer. Alternatively, the catalyst layer can be formed on the ion exchange membrane as follows: a coating layer is formed by applying the above-described liquid coating composition to a separately prepared substrate, and then the coating layer thus formed is transferred onto the ion exchange membrane.

In this connection, when the catalyst layer is formed on the gas diffusion layer, it is preferable to bond the catalyst layer and the ion exchange membrane to each other with an adhesion method or a hot press method. Also when the catalyst layer is formed on the ion exchange membrane, the cathode may be formed only of the catalyst layer, or may be formed by further disposing a gas diffusion layer so as to be adjacent to the catalyst layer.

A separator with gas flow paths formed thereon is usually disposed outside the cathode; a hydrogen-containing gas is fed to the anode and an oxygen-containing gas is fed to the cathode through the gas flow paths, and thus a polymer electrolyte fuel cell is constituted.

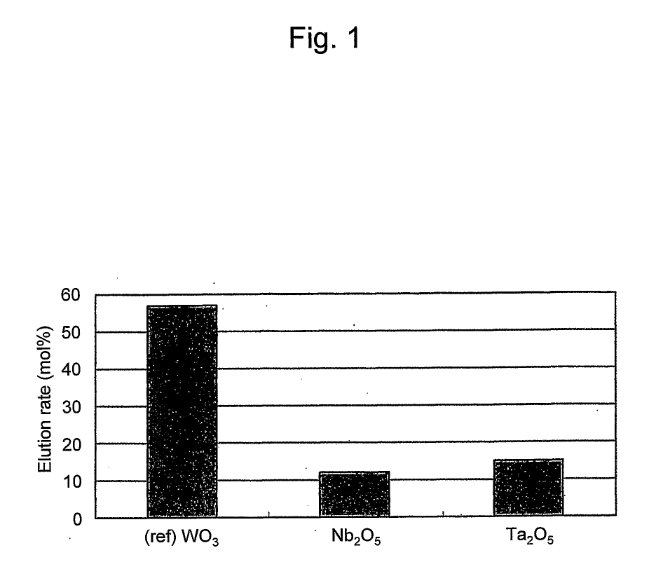

FIG. 1 shows the results of an electrochemical elution test for a conventional sintering preventing agent WO₃, and sintering preventing agents of the present invention, namely, an oxide of niobium (Nb₂O₅) and an oxide of tantalum (Ta₂O₅). In the electrochemical elution test, 10000 cycles of 0.6 V to 1.0 V vs. RHE in 0.1-N H₂SO₄ were applied and thereafter the eluted amounts of the metals into the electrolyte were analyzed to derive the respective elution rates.

As can be seen from the results shown in FIG. 1, WO₃ is extremely high in elution rate despite being a sintering preventing agent, and is not necessarily suitable as a sintering preventing agent; on the other hand, the oxide of niobium (Nb₂O₅) and the oxide of tantalum (Ta₂O₅) used in the present invention are extremely small in elution rate even after a harsh cycle test.

### EXAMPLES

Hereinafter, the fuel cell electrode catalyst, the fuel cell cathode and the polymer electrolyte fuel cell of the present invention are described in detail with reference to Examples and Comparative Examples.

### Sample Preparation

### Example 1

A Nb₂O₅ (30 wt %)/Pt/C catalyst was prepared according to the following procedures, an MEA was fabricated and the MEA was assembled to the cell, and then performance was evaluated.

(1) A mixture Pt (45 wt %)/C was suspended in purified water.
(2) A predetermined amount of NbCl₃ was dissolved in purified water and stirred for 2 hours.
(3) Under stirring, a reducing agent such as aqueous ammonia was added dropwise until a precipitate was produced.
(4) A 2-hour stirring was made.
(5) Centrifugal separation, washing with water and filtration were carried out.
(6) Drying in an inert gas atmosphere was carried out at 80° C. for 6 hours.
(7) The dried product was allowed to stand in the air for about 12 hours.
(8) A predetermined amount of the thus obtained Nb₂O₅ (30 wt %)/Pt/C catalyst was mixed with a mixture composed of purified water, an electrolyte solution (Nafion: trade name), ethanol and polyethylene glycol (Nafion/Carbon=1.0 wt %) to prepare a catalyst ink.
(9) The catalyst ink was cast on a Teflon (trade name) resin film (film thickness: 6 mil), dried and cut to a size of 13 (cm²).
(10) The catalyst layer thus prepared was thermocompression bonded to an electrolyte membrane to fabricate an MEA.
(11) The MEA was assembled to the cell, and the cell was subjected to an endurance test and a performance evaluation.

### Example 2

A Ta₂O₅ (30 wt %)/Pt/C catalyst was prepared according to the following procedures, an MEA was fabricated and the MEA was assembled to the cell, and then performance was evaluated.

(1) A mixture Pt (45 wt %)/C was suspended in purified water.
(2) A predetermined amount of TaCl₅ was dissolved in purified water and stirred for 2 hours.
(3) Under stirring, a reducing agent such as aqueous ammonia was added dropwise until a precipitate was produced.
(4) A 2-hour stirring was made.
(5) Centrifugal separation, washing with water and filtration were carried out.
(6) Drying in an inert gas atmosphere was carried out at 80° C. for 6 hours.
(7) The dried product was allowed to stand in the air for about 12 hours.
(8) A predetermined amount of the thus obtained Ta₂O₅ (30 wt %)/Pt/C catalyst was mixed with a mixture composed of purified water, an electrolyte solution (Nafion: trade name), ethanol and polyethylene glycol (Nafion/Carbon=1.0 wt %) to prepare a catalyst ink.
(9) The catalyst ink was cast on a Teflon (trade name) resin film (film thickness: 6 mil), dried and cut to a size of 13 (cm²).
(10) The catalyst layer thus prepared was thermocompression bonded to an electrolyte membrane to fabricate an MEA.
(11) The MEA was assembled to the cell, and the cell was subjected to an endurance test and a performance evaluation.

### Comparative Example 1

A WO₃ (30 wt %)/Pt/C catalyst was prepared according to the following procedures, an MEA was fabricated and the MEA was assembled to the cell, and then performance was evaluated.

(1) A mixture Pt (45 wt %)/C was suspended in purified water.
(2) A predetermined amount of Na₂.WO₄.2H₂O was dissolved in purified water and stirred for 2 hours.
(3) Under stirring, HCl was added dropwise until a precipitate was produced.
(4) A 12-hour stirring was made.
(5) Centrifugal separation, washing with water and filtration were carried out.
(6) Drying in an inert gas atmosphere was carried out at 80° C. for 6 hours.
(7) The dried product was allowed to stand in the air for about 12 hours.
(8) A predetermined amount of the thus obtained WO₃ (30 wt %)/Pt/C catalyst was mixed with a mixture composed of purified water, an electrolyte solution (Nafion: trade name), ethanol and polyethylene glycol (Nafion/Carbon=1.0 wt %) to prepare a catalyst ink.
(9) The catalyst ink was cast on a Teflon (trade name) resin film (film thickness: 6 mil), dried and cut to a size of 13 (cm²).
(10) The catalyst layer thus prepared was thermocompression bonded to an electrolyte membrane to fabricate an MEA.
(11) The MEA was assembled to the cell, and the cell was subjected to an endurance test and a performance evaluation.

### Comparative Example 2

A TiO₂ (30 wt %)/Pt/C catalyst was prepared according to the following procedures, an MEA was fabricated and the MEA was assembled to the cell, and then performance was evaluated.

(1) A mixture Pt (45 wt %)/C was suspended in purified water.
(2) A predetermined amount of Ti-isopropoxide was added to (1) and stirred for 12 hours.
(3) Centrifugal separation, washing with water and filtration were carried out.
(4) Drying in an inert gas atmosphere was carried out at 80° C. for 6 hours.
(5) The dried product was allowed to stand in the air for about 12 hours.
(6) A predetermined amount of the thus obtained TiO₂ (30 wt %)/Pt/C catalyst was mixed with a mixture composed of purified water, an electrolyte solution (Nafion: trade name), ethanol and polyethylene glycol (Nafion/Carbon=1.0 wt %) to prepare a catalyst ink.
(7) The catalyst ink was cast on a Teflon (trade name) resin film (film thickness: 6 mil), dried and cut to a size of 13 (cm²).
(8) The catalyst layer thus prepared was thermocompression bonded to an electrolyte membrane to fabricate an MEA.
(9) The MEA was assembled to the cell, and the cell was subjected to an endurance test and a performance evaluation.

### Comparative Example 3

An Al₂O₃ (30 wt %)/Pt/C catalyst was prepared in the same procedures as in Comparative Example 1 except that Al-isopropoxide was used in place of Ti-isopropoxide, an MEA was fabricated, the MEA was assembled to the cell, and the performance was evaluated.

### Comparative Example 4

A Pt/C catalyst was prepared by conducting only the procedures (8) to (11) in Example 1, an MEA was fabricated, the MEA was assembled to the cell and the performance was evaluated.

### [Conditions for Electric Potential Variation Endurance Test]

Electric potential control: ON-OFF (0.65 V, 10 s [symbol] OCV, 10 s)
Cathode: Air, stoichiometry 4, 70° C., 0.05 MPa
Anode: H₂, stoichiometry 4, 55° C., 0.1 MPa

### Cell: 80° C.

### [Process for Deriving the Maintenance Rate of the Catalyst Reaction Area]

At 3600, 9000, 18000 and 28000 cycles in the above described endurance test, the cathode was converted to N₂, and CV (cyclic voltammetry) was carried out at 15 mV/sec to evaluate the electric quantity (mC) of oxidation of the absorbed hydrogen. From the result thus obtained, the catalyst reaction surface area (cm²) was calculated and divided by the initial value to derive the maintenance rate of the reaction area.

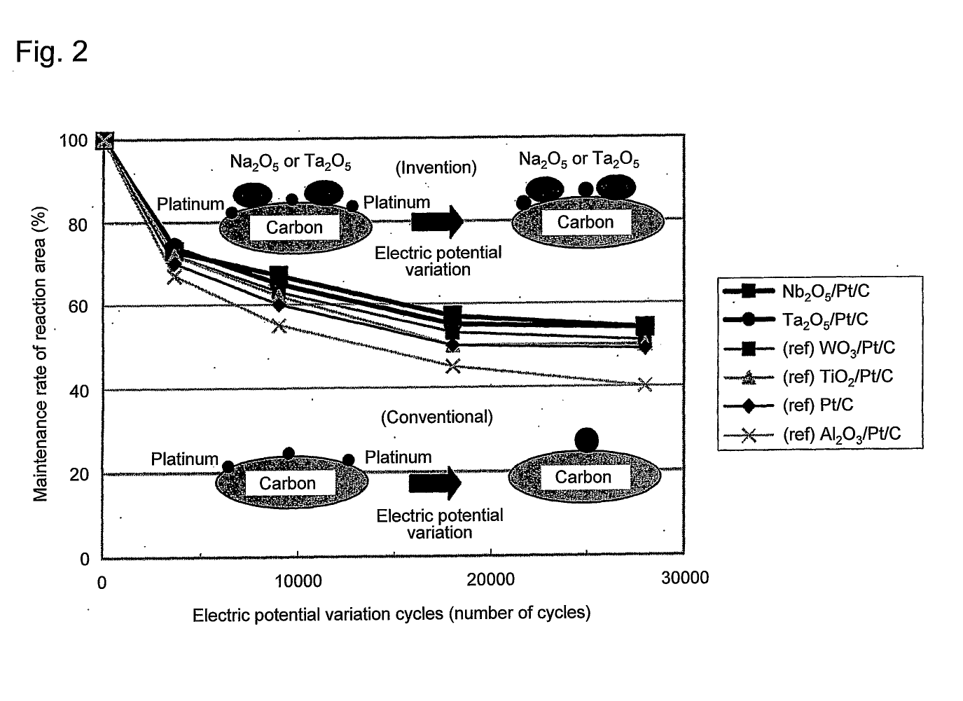

FIG. 2 shows the maintenance rate transition of the catalyst reaction area brought about by the endurance of the electric potential variation. As can be seen from the results shown in FIG. 2, the Nb₂O₅ (30 wt %)/Pt/C of Example 1 and the Ta₂O₅ (30 wt %)/Pt/C of Example 2 according to the present invention were able to alleviate the reaction area degradation as compared to the WO₃ (30 wt %)/Pt/C of Comparative Example 1, the TiO₂ (30 wt %)/Pt/C of Comparative Example 2, the Al₂O₃ (30 wt %)/Pt/C of Comparative Example 3 and the Pt/C of Comparative Example 4. This is conceivably ascribed to that the supported oxides Nb₂O₅ and Ta₂O₅ suppressed the migration of the metal catalyst on the surface of the support and prevented the coagulation of the metal catalyst.

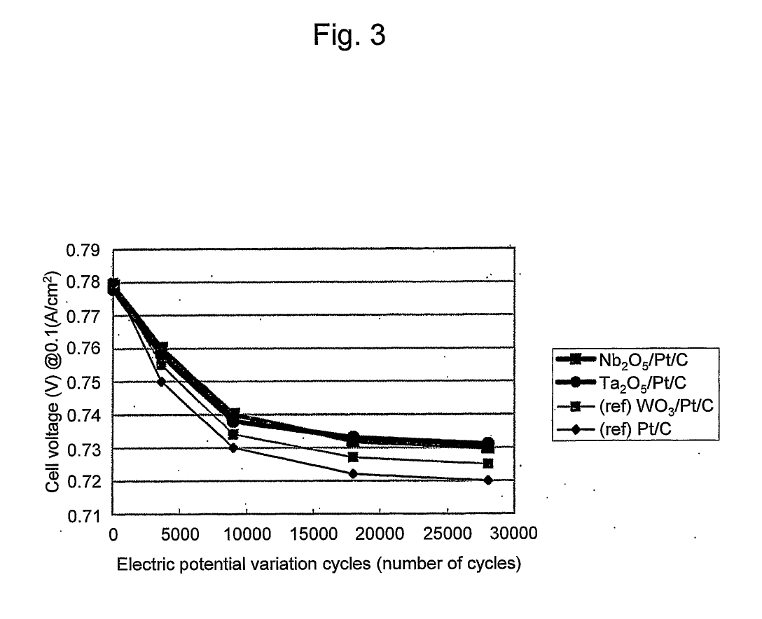

FIG. 3 shows the results of the performance degradation brought about by the electric potential variation test. Plot of the measured values of the cell voltage at the 3600, 9000, 18000 and 28000 cycles in the above-described endurance test revealed that the Nb₂O₅ (30 wt %)/Pt/C of Example 1 and the Ta₂O₅ (30 wt %)/Pt/C of Example 2 according to the present invention were smaller in cell voltage degradation, despite the increased number of the electric potential variation cycles, as compared to the WO₃ (30 wt %)/Pt/C of Comparative Example 1 and the Pt/C of Comparative Example 4. Consequently, it has been found that the fuel cell according to the present invention is excellent in durability and high in applicability.

### INDUSTRIAL APPLICABILITY

According to the present invention, by further supporting the oxide of niobium (Nb₂O₅) and/or the oxide of tantalum (Ta₂O₅) on the catalyst-supported conductive material, the coagulation of the metal catalyst particles due to the fuel cell operation is suppressed, and the reaction area degradation of the metal catalyst and the performance degradation of the fuel cell are alleviated. Accordingly, a high power generation performance can be maintained over a long period of time. In particular, even when the fuel cell undergoes the cycles of the electric potential variation, the fuel cell can display a high durability. Consequently, the present invention contributes to the practical application and the expanded use of the fuel cell.

1. A fuel cell catalyst characterized in that a metal catalyst and an oxide of niobium (Nb₂O₅) and/or an oxide of tantalum (Ta₂O₅) are supported on a conductive support.

2. A fuel cell cathode comprising a catalyst layer composed of a metal catalyst-supported conductive material and a polymer electrolyte, the fuel cell cathode being characterized in that the oxide of niobium (Nb₂O₅) and/or the oxide of tantalum (Ta₂O₅) is further supported on the catalyst-supported conductive material.

3. A polymer electrolyte fuel cell comprising an anode, a cathode and a polymer electrolyte membrane disposed between the anode and the cathode, the polymer electrolyte fuel cell being characterized in that:
the cathode comprises a catalyst layer composed of a metal catalyst-supported conductive material and a polymer electrolyte; and
the oxide of niobium (Nb₂O₅) and/or the oxide of tantalum (Ta₂O₅) is further supported on the catalyst-supported conductive material.
